(19) United States
(12) Patent Application Publication
(10) Pub. No.: US 2006/0280528 A1
(43) Pub. Date: Dec. 14, 2006

(54) Developer for electrophotographic image forming apparatus

(75) Inventor: Ki-jae Do, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/449,651

(22) Filed: Jun. 9, 2006

(30) Foreign Application Priority Data
Jun. 11, 2005 (KR) 10-2005-0050147

(51) Int. Cl. G03G 15/08

(52) U.S. Cl. 399/279; 399/281; 399/285; 399/283; 399/284

(57) ABSTRACT

A developer for an electrophotographic image forming apparatus including a toner charging roller is provided. The developer includes: a developing roller which faces a photosensitive medium and rotates to transfer toner to the photosensitive medium to develop the electrostatic latent image on the photosensitive medium; a supply roller which faces the developing roller and rotates to supply the toner to the developing roller; a regulating blade which is provided at one side of the developing roller and regulates the toner supplied onto the surface of the developing roller to have a uniform thickness, and triboelectrically charges the toner; and a toner charging roller which faces the developing roller and rotates to triboelectrically charge the toner between the supply roller and the regulating blade.

### CROSS-REFERENCE TO RELATED PATENT APPLICATION

This application claims the benefit of Korean Patent Application No. 10-2005-0050147, filed on Jun. 11, 2005, in the Korean Intellectual Property Office, the disclosure of which is incorporated herein by reference in its entirety.

### BACKGROUND OF THE INVENTION

1. Field of the Invention

The present invention relates to a developer for an electrophotographic image forming apparatus. More particularly, the invention relates to a developer for an electrophotographic image forming apparatus using a non-magnetic mono-component development method.

2. Description of the Related Art

Generally, in an electrophotographic image forming apparatus, an electrostatic latent image is formed onto a charged photosensitive medium by irradiation of light. The electrostatic latent image is developed using a powder toner into a toner image, and the toner image is then transferred and fixed to a sheet of paper to form an image. Accordingly, the electrophotographic image forming apparatus includes a developer containing the powder toner to develop the electrostatic latent image.

FIG. 1 is a schematic view illustrating a structure of a conventional electrophotographic image forming apparatus. Referring to FIG. 1, the electrophotographic image forming apparatus includes a photosensitive medium 11 rotating in a predetermined direction, a charger 12 charging the surface of the photosensitive medium 11 to a predetermined electric potential, a light exposure unit 13 for irradiating light onto the photosensitive medium 11 in response to a computer signal, a developer 14 for developing the exposed portion with toner 18 so as to form a toner image on the surface of the photosensitive medium 11, and a transfer unit 19 transferring the toner image onto a sheet of paper.

The developer 14 includes a developing roller 15 developing the electrostatic latent image by using a toner layer attached to the surface thereof, a supply roller 16 supplying the toner 18 to the surface of the developing roller 15, and a regulating blade 17 forming the toner layer having a predetermined thickness on the developing roller 15.

In the aforementioned configuration of the developer 14, the toner 18 is supplied to the developing roller 15 by the supply roller 16. The toner 18 transferred to the developing roller 15 becomes a thin layer having a uniform thickness by means of the regulating blade 17 as the developing roller 15 rotates. In addition, the toner 18 is triboelectrically charged by friction between the developing roller 15 and the regulating blade 17 forming a thin layer.

The triboelectrically charged toner 18 forms the toner image on the photosensitive medium by moving toward the electrostatic latent image formed on the surface of the photosensitive medium from the developing roller 5 along the electric field. The transfer unit 19 transfers the toner image onto the sheet of paper and the transfer unit 19 then fixes the transferred toner image thereto by heat and pressure. Meanwhile, the toner remaining on the surface of the photosensitive medium 11 is removed by a cleaner.

Accordingly, the toner 18 is triboelectrically charged mainly by friction between the developing roller 15 and the regulating blade 17. However, since the charging of the toner 18 is not always consistent, the inconsistent charging can cause the toner to have opposite polarities. The toner having opposite polarities may move to areas other than the electrostatic latent image on the photosensitive medium 11, thereby resulting in background contamination.

### SUMMARY OF THE INVENTION

The present invention provides a developer for an electrophotographic image forming apparatus in which a toner supplied onto the surface of a developing roller is triboelectrically charged prior to reaching a regulating blade so as to improve the charging characteristic of the toner.

According to an aspect of the present invention, developer for an electrophotographic image forming apparatus which develops an electrostatic latent image formed on the surface of a photosensitive medium by supplying non-magnetic mono-component toner to the electrostatic latent image is provided. The developer comprises: a developing roller facing a photosensitive medium and rotating to transfer toner to the photosensitive medium to develop the electrostatic latent image on the photosensitive medium; a supply roller facing the developing roller and rotating to supply the toner to the developing roller; a regulating blade on one side of the developing roller to regulate the toner supplied onto the surface of the developing roller to have a uniform thickness, and triboelectrically charge the toner; and a toner charging roller facing the developing roller and rotating to triboelectrically charge the toner between the supply roller and the regulating blade.

The toner charging roller may rotate in a direction opposite to the rotation direction of the supply roller to supply the toner smoothly to the developing roller between the toner charging roller and the supply roller. The toner charging roller rotates in contact with the developing roller. When the surface of the developing roller is made of a soft material, the surface of the toner charging roller may be made of a hard material. When the surface of the developing roller is made of a hard material, the surface of the toner charging roller may be made of a soft material. In the latter case, a core of the toner charging roller may be made of a hard material covered with a soft material.

The toner charging roller may be applied with a bias voltage to form a predetermined supply electric field with respect to the developing roller. For example, when a negative-charged toner is used, the toner charging roller may apply a voltage lower than the bias voltage of the developing roller, so that the negative-charged toner by triboelectrical charging is distributed on the surface of the developing roller. When a positive-charged toner is used, the toner charging roller may apply a bias voltage so as to form an opposite electric field.

According to another aspect of the present invention, a developer is provided for an electrophotographic image forming apparatus which develops an electrostatic latent image formed on the surface of a photosensitive medium by supplying non-magnetic mono-component toner to the electrostatic latent image. The developer comprises: a developing roller facing a photosensitive medium placed a predetermined gap therefrom and rotating to transfer toner to the photosensitive medium to develop the electrostatic latent image on the photosensitive medium; a supply roller facing the developing roller and rotating to supply the toner to the developing roller. A regulating blade is provided at one side of the developing roller to regulate the toner supplied onto the surface of the developing roller to have a uniform thickness, and triboelectrically charges the toner; and a toner charging roller which faces the developing roller and rotates to triboelectrically charge the toner between the supply roller and the regulating blade, wherein a bias voltage having a DC component and an AC component is applied to the developing roller.

In a so-called non-contact type developer, a predetermined gap is interposed between the photosensitive medium and the developing roller, and the charged state of the toner has a greater affect on the development than in a contact type developer. However, the triboelectrical charging of the toner is not easy. Therefore, an additional toner charging means is required.

The supply roller may be applied with a bias voltage to form a predetermined supply electric field to supply the toner to the developing roller. The AC component thereof may be synchronized with the AC component of the bias voltage of the developing roller.

The toner charging roller may be applied with a bias voltage to form a predetermined supply electric field with respect to the developing roller. The AC component thereof may be synchronized with the AC component of the bias voltage of the developing roller. This is because a constant supply electric field should be formed to prevent collection of the toner distributed on the surface of the developing roller caused by friction. Since this is also valid for the supply roller and the toner charging roller, a common bias voltage may be applied to the supply roller and the toner charging roller.

These and other salient features of the invention will become apparent from the following detailed description of the invention and the drawings which disclose various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating a structure of a conventional electrophotographic image forming apparatus;

FIG. 2 is a view illustrating of a developer according to an embodiment of the present invention;

FIG. 3 is a view illustrating an example of operations of the developer of FIG. 2, according to an embodiment of the present invention; and

FIG. 4 illustrates a distribution of the quantity of charges (q/d) in the developer of FIG. 2, according to an embodiment of the present invention.

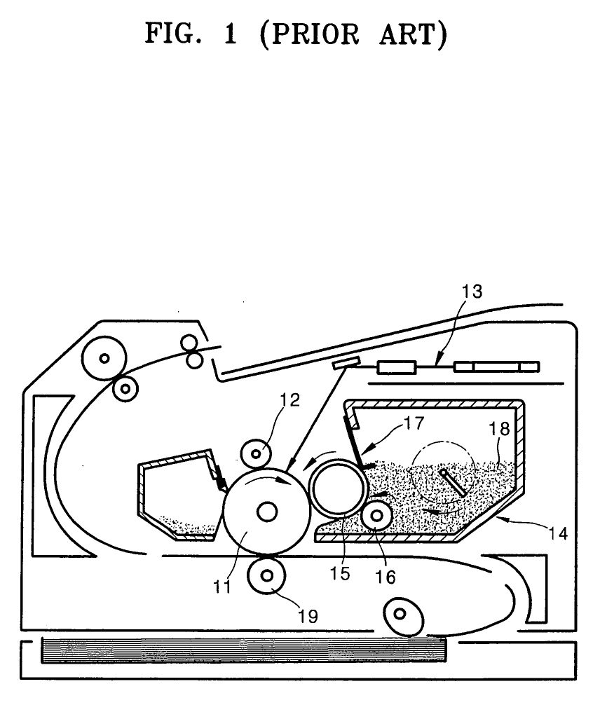

### DETAILED DESCRIPTION OF THE INVENTION

Hereinafter, exemplary embodiments of the present invention will be described in detail with reference to the accompanying drawings.

FIG. 2 illustrates of a developer according to an embodiment of the present invention. An electrophotographic image forming apparatus according to an embodiment of the present invention includes a photosensitive medium 11 that rotates in a predetermined direction, and a charger 12 that charges the surface of the photosensitive medium 11 to have a predetermined electric potential. A light exposure unit 13 irradiates light onto the photosensitive medium 11 in response to a computer signal to form a latent image. A developer 14 develops the latent image and the exposed portion of the photosensitive medium 11 using toner 18 to form a toner image on the surface of the photosensitive medium 11. A transfer unit 19 transfers the toner image from the photosensitive medium onto a sheet of paper.

In the developer 14, a developing roller 15 is provided to develop an electrostatic latent image using a toner layer attached on the surface thereof. A supply roller 16 attaches the toner 18 onto the surface of the developing roller 15. A regulating blade 17 regulates the toner layer attached onto the developing roller 15 to have a predetermined thickness. In addition, as a characteristic of the present invention, a toner charging roller 20 is provided in the developer 14.

The toner charging roller 20 is disposed between the supply roller 16 and the regulating blade 17 and rotates while facing the developing roller 15. The toner charging roller 20 is preferably disposed in contact with the surface of the developing roller 15 so as to be effectively in contact with the toner attached to the surface of the developing roller 15. The supply roller 16 is also preferably disposed in contact with the surface of the developing roller 15. The contact pressures between the toner charging roller 20 and the developing roller 15 may be less than or equal to the contact pressure between the supply roller 16 and the developing roller 15.

As mentioned above, since the toner charging roller 20 and the developing roller 15 are in contact with each other, the surface of one of the rollers is made of a hard material, and the surface of the other roller is preferably made of a soft material to maintain an adequate contact pressure and to improve the durability of the rollers. The soft material may be a rubber or a soft resin, and the hard material may be a metal or a hardened plastic. For example, where the surface of the developing roller 15 is made of a soft material such as a nitrile butadiene rubber (NBR) the surface of the toner charging roller 20 is preferably made of aluminum or an aluminum alloy. On the contrary, where the surface of the developing roller 15 is made of a hard material, the surface of the toner charging roller 20 is preferably made of a soft material. In this case, the toner charging roller 20 can be composed of a core 21 of made of a hard material such as a metal and a cover 22 made of a soft material such as a rubber or a resin.

It is preferable that the rotation direction of the toner charging roller 20 is opposite to that of the developing roller 15 and the supply roller 16. In this manner, the toner 18 can be readily supplied in the direction depicted by the arrows in FIG. 2, and the toner 18 can be charged while being attached to the developing roller 15.

In the developer 14 configured as shown in FIG. 2, the toner 18 is supplied to the developing roller 15 by the supply roller 16. The supply roller 16 supplies the toner 18 and at the same time performs a first triboelectric charging, by rotating in contact with the developing roller 15. On the other hand, the toner which is not developed and remains on the surface of the developing roller 15 may be collected. The supply roller 16 rotates in the same direction as the developing roller 15, so at the contact point, the surfaces of rollers 15 and 16 move in the opposite direction with each other as shown in FIG. 2.

The toner 18 attached to the surface of the developing roller 15 by the supply roller 16 contacts the toner charging roller 20 as the developing roller 15 rotates. In a conventional developer, the toner 18 is charged mainly in a thin layer process performed by the regulating blade 17. In the developer 14 according to the present invention, however, the toner 18 is triboelectrically charged in advance of the regulating blade 17 by the contact between the developing roller 15 and the toner charging roller 20. The toner 18, which reaches the regulating blade 17 after being charged by the toner charging roller 20, is triboelectrically charged again by the developing roller 15 and the regulating blade 17. In this manner, the toner 18 attached to the surface of the developing roller 15 is subject to a number of frictional operations to uniformly triboelectrically significantly charge the toner, so that the quantity of charges (q/d) is uniformly distributed, and to reduce the frequency of oppositely polarized toner. The regulating blade 17 may be positioned not only in a leading manner as shown in FIG. 2 but also in any known manner such as a trail manner.

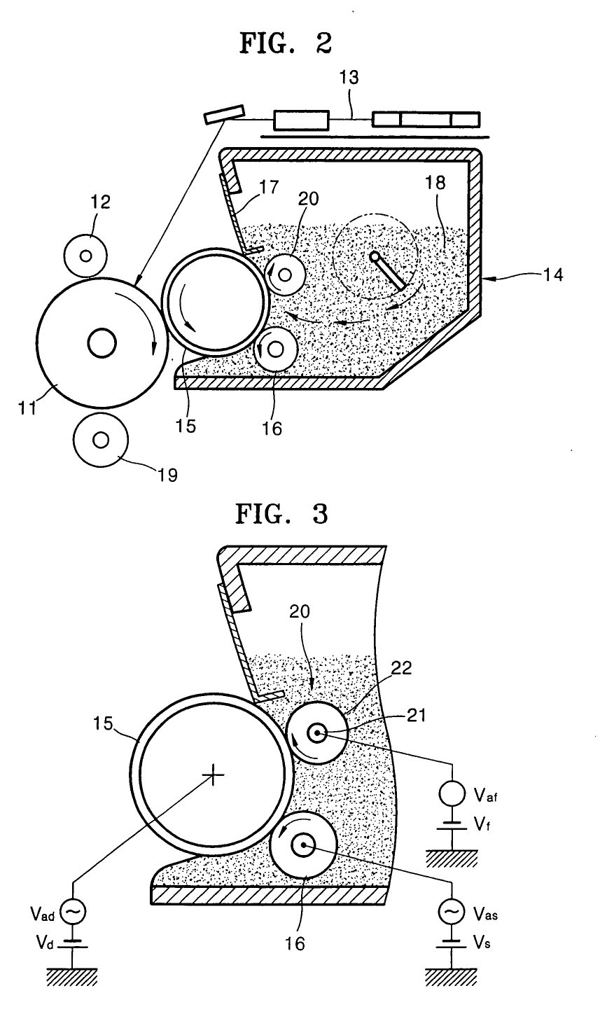

FIG. 3 illustrates an example of the operation of the developer 14 of FIG. 2, according to an embodiment of the present invention. As in a typical non-contact type developer, a bias voltage having a DC component Vd and an AC component Vad is applied to the developing roller 15. For convenience, the bias voltage will be referred to as a developing bias Vd+Vad.

Meanwhile, a bias voltage having a DC component Vs and an AC component Vas is also applied to the supply roller 16. Between the developing roller 15 and the supply roller 16, a predetermined supply electric field must be formed. For example, in a case where the toner 18 is charged to have a negative polarity, the electric potential of the supply roller 16 among the two rollers 15 and 16 must be lower. Thus, preferably, Vd>Vs and Vad=Vas, and the AC component Vas in the bias voltage of the supply roller 16 is preferably synchronized with the AC component Vad in the developing bias Vd+Vad.

The toner charging roller 20 is also applied with a bias voltage such that the supply electric field is formed with respect to the developing roller 15. Preferably, Vd=Vf and Vad=Vaf, and the AC component Vaf in the bias voltage of the toner charging roller 20 is preferably synchronized with the AC component Vad in the developing bias Vd+Vad. The bias voltage of the toner charging roller 20 may have only the direct current component, but when the difference from the developing bias Vd+Vad becomes excessive, a leakage current may be generated between the two rollers 15 and 20.

In this manner, the bias voltage which forms the supply electric field in the same direction with respect to the developing roller 15 is applied to the supply roller 16 and the toner charging roller 20, and both two rollers 16 and 20 are applied with a bias voltage so as to have the AC component synchronized with the AC component in the developing bias Vd+Vad. A common bias voltage may be applied to the two rollers 16 and 20.

In another embodiment of the present invention, the regulating blade 17 is made of a stainless steal (SUS) plate as in the prior art, and is adhered closely to the developing roller 15 by a pressure of 10˜50 g/cm². The surface of the developing roller 15 may be made of a soft material, such as nitrile butadiene rubber (NBR), the surface roughness is 3˜9 μm, and the resistance is approximately 1×10⁵˜5×10⁶ Ω. The gap between the developing roller 15 and the photosensitive medium is maintained to be 150˜400 μm, and the developing bias Vd+Vad is applied such that a direct voltage Vd is−500 V, a peak-to-peak amplitude Vadₚ₋ₚ of an AC component is 1.8 kV, a frequency is 2.0 kHz, and a duty(−) is 35%.

The surface of the supply roller 16 is made of urethane foam and disposed in a rotatable manner, maintaining a predetermined nip width in contact with the developing roller 15. As for the bias voltage of the supply roller 16, in order to form the supply electric field capable of supplying a negatively charged toner with respect to the developing roller 15, the direct voltage Vs is set to −700V, and the alternating component Vas is applied equivalently to the developing bias Vd+Vad with respect to an alternating component, an amplitude, a frequency, and a phase.

The toner charging roller 20 is made of a hard material, such as a metal rod, and disposed in a rotatable manner, maintaining a predetermined nip width in contact with the developing roller 15. The bias voltage of the toner charging roller 20 may be applied in common with the bias voltage of the supply roller 16. As for the toner 18, a so-called pulverized toner, that is, pulverized toner after dispersing a coloring agent onto a thermal-plastic resin such as polyester is used, and an average particle diameter thereof may be approximately 8.0 μm.

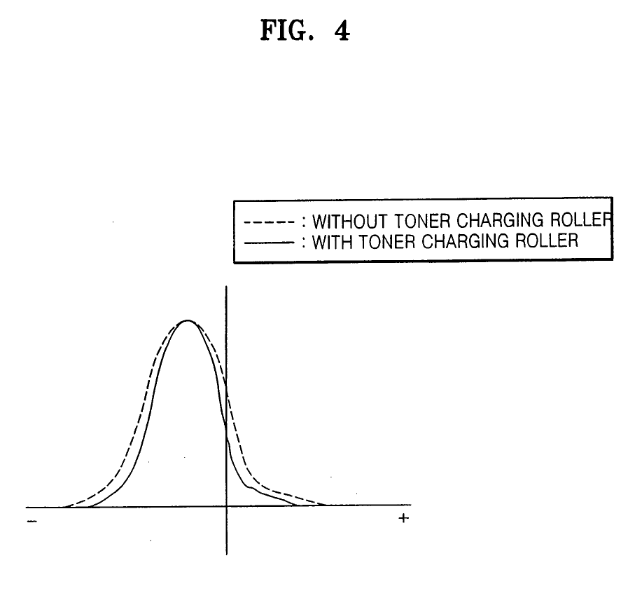

FIG. 4 illustrates a distribution of the quantity of charges (q/d) in the developer of FIG. 2 according to an embodiment of the present invention. An experimental result based on the aforementioned specific embodiment is shown, and the cases of using and not using a toner charging roller are compared in the same conditions except that the toner layer on the developing roller 15 is in the range of 0.45 to 0.655 mg/cm² . According to the present invention, as shown in FIG. 4, it can be seen that the amount of the toner which is reversely charged or over charged is significantly reduced.

Accordingly, in a developer for an electrophotographic image forming apparatus according to the present invention, a toner supplied onto the surface of a developing roller is triboelectrically charged prior to reaching a regulating blade, and charged again by the regulating blade, to reduce significantly the frequency of having the toner of a reverse polarity.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A developer for an electrophotographic image forming apparatus which develops an electrostatic latent image formed on the surface of a photosensitive medium by supplying non-magnetic mono-component toner to the electrostatic latent image, the developer comprising:
a developing roller facing a photosensitive medium and rotating to transfer toner to the photosensitive medium to develop the electrostatic latent image on the photosensitive medium;
a supply roller facing the developing roller and rotating to supply the toner to the developing roller;
a regulating blade at one side of the developing roller to regulate the toner supplied onto the surface of the developing roller to have a uniform thickness, and triboelectrically charge the toner; and
a toner charging roller facing the developing roller and rotating to triboelectrically charge the toner between the supply roller and the regulating blade.

2. The developer according to claim 1, wherein the toner charging roller rotates in a direction opposite to the rotation direction of the supply roller so as to supply the toner smoothly to the surface of the developing roller between the toner charging roller and the supply roller.

3. The developer according to claim 1, wherein the surface of the developing roller is made of a soft material and the surface of the toner charging roller is made of a hard material that is harder than the soft material of said developing roller.

4. The developer according to claim 1, wherein the surface of the developing roller is made of a hard material and the surface of the toner charging roller is made of a soft material that is softer than the hard material of said developing roller.

5. The developer according to claim 4, wherein the toner charging roller is made by forming a rubber layer or a synthetic resin layer on the surface of a metal core.

6. The developer according to claim 1, wherein the toner charging roller is applied with a bias voltage to form a predetermined supply electric field with respect to the developing roller.

7. The developer according to claim 1, wherein the supply roller collects the toner not used to develop the electrostatic latent image.

8. A developer for an electrophotographic image forming apparatus which develops an electrostatic latent image formed on the surface of a photosensitive medium by supplying non-magnetic mono-component toner to the electrostatic latent image, the developer comprising:
a developing roller facing a photosensitive medium placed a predetermined gap therefrom which rotates to transfer toner to the photosensitive medium to develop the electrostatic latent image on the photosensitive medium;
a supply roller facing the developing roller which rotates to supply the toner to the developing roller;
a regulating blade at one side of the developing roller to regulate the toner supplied onto the surface of the developing roller to have a uniform thickness, and to triboelectrically charge the toner; and
a toner charging roller facing the developing roller and rotates to triboelectrically charge the toner between the supply roller and the regulating blade,
wherein a bias voltage having a DC component and an AC component is applied to the developing roller.

9. The developer according to claim 8, wherein the supply roller is applied with a bias voltage so as to form a predetermined supply electric field with respect to the developing roller and the AC component of the biased voltage is synchronized with the bias voltage of the developing roller.

10. The developer according to claim 9, wherein a common bias voltage is applied to the supply roller and the toner charging roller.

11. The developer according to claim 8, wherein the toner charging roller is applied with a bias voltage to form a predetermined supply electric field with respect to the developing roller and the AC component of the bias voltage is synchronized with the bias voltage of the developing roller.

12. The developer according to claim 11, wherein a common bias voltage is applied to the supply roller and the toner charging roller.

13. The developer according to claim 8, wherein the supply roller collects the toner not used to develop the electrostatic latent image.

14. An electrophotographic image forming apparatus having a developer which develops an electrostatic latent image formed on the surface of a photosensitive medium by supplying non-magnetic mono-component toner to the electrostatic latent image, the developer comprising:
a developing roller facing a photosensitive medium and rotating to transfer toner to the photosensitive medium to develop the electrostatic latent image on the photosensitive medium;
a supply roller facing the developing roller and rotating to supply the toner to the developing roller;
a regulating blade at one side of the developing roller to regulate the toner supplied onto the surface of the developing roller to have a uniform thickness, and triboelectrically charge the toner; and
a toner charging roller facing the developing roller and rotating to triboelectrically charge the toner between the supply roller and the regulating blade.

15. The electrophotographic image forming apparatus according to claim 14, wherein the toner charging roller rotates in a direction opposite to the rotation direction of the supply roller so as to supply the toner smoothly to the surface of the developing roller between the toner charging roller and the supply roller.

16. The electrophotographic image forming apparatus according to claim 14, wherein the surface of the developing roller is made of a soft material and the surface of the toner charging roller is made of a hard material that is harder than the soft material of said developing roller.

17. The electrophotographic image forming apparatus according to claim 14, wherein the surface of the developing roller is made of a hard material and the surface of the toner charging roller is made of a soft material that is softer than the hard material of said developing roller.

18. The electrophotographic image forming apparatus according to claim 17, wherein the toner charging roller is made by forming a rubber layer or a synthetic resin layer on the surface of a metal core.

19. The electrophotographic image forming apparatus according to claim 14, wherein the toner charging roller is applied with a bias voltage to form a predetermined supply electric field with respect to the developing roller.

20. The electrophotographic image forming apparatus according to claim 14, wherein the supply roller collects the toner not used to develop the electrostatic latent image.
